(19) United States
(12) Patent Application Publication
(10) Pub. No.: US 2002/0107915 A1
(43) Pub. Date: Aug. 8, 2002

(54) Protocol-independent JSP invocation

(76) Inventors: Afshan Ally, Markham (CA); Michael S. Roy-Diclemente, Richmond Hill (CA); John W. Stephenson, Oshawa (CA)

Correspondence Address: Gail H. Zarick, Intellectual Property Law Dept., IBM Corporation, P.O. Box 218, Yorktown Heights, NY, 10598, US

(21) Appl. No.: 09/997,186

(22) Filed: Nov. 28, 2001

(30) Foreign Application Priority Data
Nov. 30, 2000 (CA) 2,327,197

(51) Int. Cl. G06F 15/16

(52) U.S. Cl. 709/203; 709/219

(57) ABSTRACT

A system is provided to permit page definitions in the Java Server Pages standard (JSP pages) may be invoked in response to non-HTTP protocol requests. An adapter is created by a servlet in a web server. The adapter receives requests which may include non-HTTP requests. A composition service is provided that is usable for both HTTP and non-HTTP format requests. Within the composition service, the protocol of the request is evaluated. Where the request is an HTTP request, specified JSP files may be executed directly from the service. Where the request is a non-HTTP request, the composition service carries out steps to ensure that specified JSP files are executable. The composition service may generate a HTTP request to the web server to execute the specified JSP files.

### FIELD OF THE INVENTION

The present invention is directed to an improvement in computing systems and in particular to composing JSP-based messages independently of request protocol.

### BACKGROUND OF THE INVENTION

In web-based environments, browsers make requests to web servers for HTML-format pages. HTML-format pages are returned by web servers to browsers using the HTTP protocol. As the need for generation of HTML pages has become greater, tools have been developed for generating sophisticated pages in response to browser requests. One technique for the generation of HTML pages for communication via HTTP protocols is provided in the Java Server Pages (JSP) standard. A JSP description replaces a fill HTML description of a page. A JSP file may contain both HTML text and Java code and will produce HTML files as output.

A given JSP file is preprocessed to create a servlet source file that when run will output any HTML text in the JSP file and will run any Java code contained in the JSP file. After compilation a byte code version of the JSP file is available for execution. The result of the execution of the byte code is the return of an HTML page to the browser which requested the page defined by the JSP.

In web servers, however, communication is not necessarily restricted to web browser-web server communication using the HTTP protocol. Other communication channels may be designed and implemented to be used in the web server environment. In current implementations for executing JSP files, the JSP functionality is invoked as part of an HTTP request. An HTTP servlet request object is needed to execute the JSP and as a result the environment for JSP execution is required to be an HTTP request environment. Where communication between a requester and a server is carried out in a using a non-HTTP protocol, prior art systems do not permit JSP execution as part of the non-HTTP communication. However, JSP functionality may be desirable in formatting messages for non-HTTP communication.

It is therefore desirable to have a messaging system that is able to utilize JSP functionality for use in communication independent of an HTTP-based request.

### SUMMARY OF THE INVENTION

According to an aspect of the present invention there is provided an improved computer system for JSP-based messaging.

According to another aspect of the present invention there is provided a computer program product for providing a composition service for invocation in a web server environment to format messages using specified JSP files, the web server comprising an adapter process for accepting and responding to non-HTTP requests, the computer program product comprising a computer usable medium having computer readable code means embodied in said medium, comprising computer readable program code means for implementing the composition service, the composition service comprising a first execution path selectable when the composition service is invoked in response to an HTTP request in which first execution path the specified JSP files are executed directly in the web server environment, the composition service comprising a second execution path selectable when the composition service is invoked in response to a non-HTTP request, in which second execution path a JSP execution method is identified for the specified JSP files and in which the specified JSP files are executed in accordance with the identified execution method.

According to another aspect of the present invention there is provided the above computer program product in which the JSP execution method is the generation of an HTTP request to the web server to execute the specified JSP files.

According to another aspect of the present invention there is provided the above computer program product in which the JSP execution method is the direct call to the servlet runtime in the web server with an object built by the composition service corresponding to the specified JSP files.

According to another aspect of the present invention there is provided a method for invoking JSP formatting for messages generated in response to a non-HTTP request made to a web server, the method comprising the following steps:

a) creating an adapter process for accepting non-HTTP requests,

b) the adapter process accepting the non-HTTP request, the request relating to a message defined by specified JSP files,

c) the adapter process generating an HTTP request to the web server corresponding to the specified JSP files,

d) the web server responding to the HTTP request by executing the specified JSP files and returning a JSP-formatted message to the adapter process, and

e) the adapter process returning the JSP-formatted message in response to the non-HTTP request.

According to another aspect of the present invention there is provided the above method in which the adapter process implements the step of generating an HTTP request to the web server, using a composition service available to format messages in response to both HTTP and non-HTTP requests.

According to another aspect of the present invention there is provided a computer program product for invoking JSP functionality for non-HTTP requests, the computer program product comprising a computer usable medium having computer readable code means embodied in said medium, comprising computer readable program code means for carrying out the above methods.

It will be recognized by those skilled in the art that the code can be carried on a medium such as a modulated carrier signal, which can be transmitted over a network such as the Internet for use by a computer.

Advantages of the present invention include the use of JSP-based message formatting not related to an HTTP request.

### BRIEF DESCRIPTION OF THE DRAWINGS

FIG. 1 is a block diagram showing components utilizing the JSP-based messaging of the preferred embodiment.

### DETAILED DESCRIPTION OF THE PREFERRED EMBODIMENT

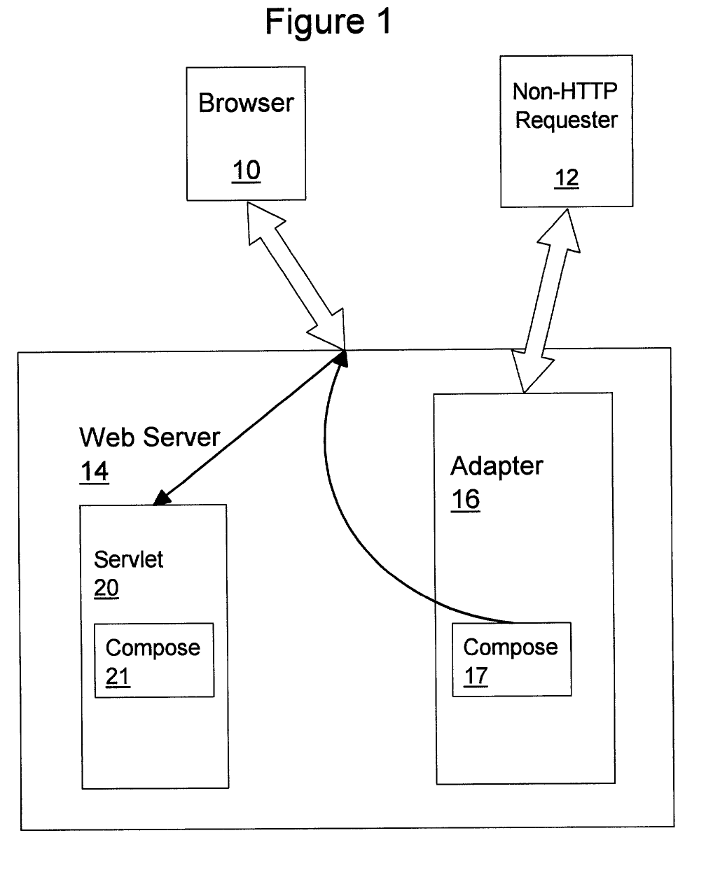

FIG. 1 is a block diagram representing components of the preferred embodiment arranged to permit non-HTTP, JSP-based formatting. FIG. 1 shows browser 10 and non-HTTP requester 12. Browser 10 communicates using HTTP with web server 14 (an HTTP server). Non-HTTP requester 12 communicates with adapter 16.

In an HTTP communication path, browser 10 makes a request to web server 14. If the request relates to a JSP-based message (i.e. a request is being made for a page with formatting defined by a JSP file) a servlet configuration object and a servlet request object are created by a servlet runtime in web server 14 (not shown).

The JSP page may include Java code which is executed to obtain data which will be included in the HTML page to be returned to browser 10. The servlet contains a forward to return the completed HTML page to the browser using the HTTP protocol. The JSP execution mechanism is designed to be invoked as the result of an HTTP request and the servlet request object that is required for execution of a JSP file is generated as a result of the receipt, by web server 14, of the HTTP request from browser 10.

According to the preferred embodiment, a process (or thread) shown in FIG. 1 as adapter 16 is created within web server 14 to permit non-HTTP communications to take place. Adapter 16 contains code to permit communication with non-HTTP requester 12. However, when a non-HTTP request is received by adapter 16, a page or data to be returned to non-HTTP requester 12 cannot be directly defined using JSP functionality as the objects that are created on receipt of an HTTP request, and that are necessary to execute a JSP file, are not generated on receipt of the non-HTTP request. Rather, to format a page, or other data to be returned to non-HTTP requester 12, adapter 16 invokes a method provided by the preferred embodiment.

As will be apparent from the description below, the composition service available for use by adapter 12 may be implemented in different ways. As the mechanism is used to access and execute JSP files, a preferred approach is to use a Java language method to implement the composition service. For this reason the description refers to a method being provided for use by adapter 16. However, other implementations are not restricted to a Java language method. The composition service provides a common mechanism usable within defined functions in the web server context to provide JSP formatting functionality The service is available whether the JSP functionality is being invoked as the result of an HTTP request or not.

In the preferred embodiment the method is the Java language compose( ) method. As may be seen from FIG. 1, the compose( ) method of the preferred embodiment is accessible from servlet 20, responding to a request from browser 10 (shown as compose( ) call 21 in FIG. 1). Likewise, compose( ) may be called from within adapter 16 (shown as compose call 17).

The compose( ) method takes as arguments formatting specifications that can be met using defined JSP files. This permits standard JSP-based composition to occur for the request made by non-HTTP requester 12. The composition service (the compose( ) method referred to above) is passed data to be used in the creation of a message. The composition service distinguishes between JSP execution made as the result of HTTP and non-HTTP requests. The calling processor or thread using the compose( ) method need not be aware of the details of how the original request was made, this is dealt with within the composition service (the compose( ) method in the preferred embodiment) as is described below. By using the composition service of the preferred embodiment, a single function may be used to carry out processing and JSP-based formatting of the result, and the single function will be available in responding to HTTP and non-HTTP requests.

In the composition service of the preferred embodiment, two execution branches are found. Where a request is made to the composition service as the result of an HTTP request (as shown in compose( ) call 21), a JSP can be executed directly. The first execution branch is executed in this case and a forward request is generated to execute appropriate JSP files using the defined servlet request object.

On the other hand, when a non-HTTP request is handled by the composition service, the second execution branch is executed. This execution branch contains functionality to ensure the JSP files are executed despite the absence of a defined servlet request object.

One method of carrying out the execution of the JSP files in the composition service where there is no HTTP request, is to have the composition service itself generate an HTTP request to web server 14 based on the required JSP execution. In the Java system of the preferred embodiment this is accomplished by building a java.net.URL object in the composition service with the appropriate data and performing a get on the contents of the URL. This creates an HTTP request to web server 14 and the JSPs specified will be run by web server 14 in the usual manner, the result being returned to the composition service invoked by adapter 16. Because the compose( ) method makes use of web server 14, the servlet objects needed to execute specified JSP files are available.

In this manner it is possible for the same composition service to provide JSP-based formatting (the generation of pages using JSP definitions) in response to both HTTP and non-HTTP requests in a web server environment.

It is contemplated that the composition service of the preferred embodiment is also able to be implemented to provide a JSP execution in response to a non-HTTP request without generating an HTTP request to the web server. This may occur where a web server architecture is such that a direct call may be made into the servlet runtime. Such a direct call will not require a servlet request object to be generated but will rely on the composition service being able to build objects required for a direct call to the servlet runtime in the web server to execute a JSP. Where such a direct call is available, the composition service may be defined to make such a call rather than building a URL as is described above. Although potentially more efficient than the alternative set out above, the availability of such a direct call to the servlet runtime will depend on the implementation details of the particular web server on which the composition service is implemented. The generation of an HTTP request by the composition service, in contrast, will be available in all typical web server environments.

Although a preferred embodiment of the present invention has been described here in detail, it will be appreciated by those skilled in the art that variations may be made thereto without departing from the spirit of the invention or the scope of the appended claims.

The embodiments of the invention in which an exclusive property or privilege are claimed are defined as follows:

1. A computer program product for providing a composition service for invocation in a web server environment to format messages using specified JSP files, the web server comprising an adapter process for accepting and responding to non-HTTP requests, the computer program product comprising a computer usable medium having computer readable code means embodied in said medium, comprising computer readable program code means for implementing the composition service,
the composition service comprising a first execution path selectable when the composition service is invoked in response to an HTTP request in which first execution path the specified JSP files are executed directly in the web server environment, the composition service comprising a second execution path selectable when the composition service is invoked in response to a non-HTTP request, in which second execution path a JSP execution method is identified for the specified JSP files and in which the specified JSP files are executed in accordance with the identified execution method.

2. The computer program product of claim 1 in which the JSP execution method comprises the generation of an HTTP request to the web server to execute the specified JSP files.

3. The computer program product of claim 1 in which the JSP execution method comprises a direct call to the servlet runtime in the web server with an object built by the composition service corresponding to the specified JSP files.

4. A method for invoking JSP formatting for messages generated in response to a non-HTTP request made to a web server, the method comprising the following steps:
a) creating an adapter process for accepting non-HTTP requests,
b) the adapter process accepting the non-HTTP request, the request relating to a message defined by specified JSP files,
c) the adapter process generating an HTTP request to the web server corresponding to the specified JSP files,
d) the web server responding to the HTTP request by executing the specified JSP files and returning a JSP-formatted message to the adapter process, and
e) the adapter process returning the JSP-formatted message in response to the non-HTTP request.

5. The method of claim 4 in which the adapter process implements the step of generating an HTTP request to the web server, using a composition service available to format messages in response to both HTTP and non-HTTP requests.

6. A computer program product for invoking JSP functionality for non-HTTP requests, the computer program product comprising a computer usable medium having computer readable code means embodied in said medium, comprising computer readable program code means for carrying out the method steps of claim 4.

7. A computer system for formatting messages using JSP files in a web server environment, the system comprising a web server, an adapter for accepting and responding to non-HTTP requests, and a composition service callable from the adapter, the composition service comprising
a first execution path selectable when the composition service is invoked in response to an HTTP request in which first execution path the specified JSP files are executed directly in the web server environment, and
a second execution path selectable when the composition service is invoked in response to a non-HTTP request, in which second execution path a JSP execution method is identified for the specified JSP files and in which the specified JSP files are executed in accordance with the identified execution method.

8. The computer system of claim 7 in which the JSP execution method comprises the generation of an HTTP request to the web server to execute the specified JSP files.

9. The computer system of claim 7 in which the JSP execution method comprises a direct call to the servlet runtime in the web server with an object built by the composition service corresponding to the specified JSP files.

10. The computer program product of claim 6 wherein said computer readable code comprises a computer readable signal and said medium comprises a computer readable signal bearing medium.

11. The computer program product of claim 10 wherein said medium is a recordable data storage medium.

12. The computer program product of claim 10 wherein the medium is a modulated carrier signal.

13. The computer program product of claim 12 wherein the signal is a transmission over a network.

14. A computer program comprising computer program code means adapted to perform all the steps of claim 4 where said program is run on a computer system.
